(19) United States
(12) Patent Application Publication
(10) Pub. No.: US 2006/0093224 A1
(43) Pub. Date: May 4, 2006

(54) Image capturing apparatus and image distributing system

(75) Inventor: Hiroshi Uchino, Otokuni-gun (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/258,277

(22) Filed: Oct. 25, 2005

(30) Foreign Application Priority Data
Oct. 29, 2004 (JP) 2004-315810

(51) Int. Cl. G06K 9/36

(52) U.S. Cl. 382/232

(57) ABSTRACT

A network camera (image capturing apparatus) extracts an image of a monitoring area and an image of a watch area from a captured image that is output from an image capturing device, and changes the size of each of the images by a scaler, thereby generating a whole image and a watch image each having a predetermined image size. JPEG data obtained by encoding an integrated image obtained by integrating the whole image and the watch image in accordance with the JPEG method is distributed to a network. A terminal which acquires the JPEG data via the network decodes the JPEG data and displays the whole image and the watch image on a display. As a result, convenience in distribution of a captured image can be improved.

### BACKGROUND OF THE INVENTION

1. Field of the Invention

The present invention relates to a technique of an image capturing apparatus capable of transmitting image data.

2. Description of the Background Art

In the case of monitoring a shop or the like by a surveillance camera (image capturing apparatus), an image area to be watched of a suspicious person or the like (watch area) is determined from a whole image of a monitoring area. In such a case, when the whole image of the monitoring area is simply displayed on a display monitor, the resolution of the watch area is too low to determine the face of a human. Consequently, an operation of magnifying the area to be watched by performing zooming or the like in the surveillance camera is necessary

In the monitoring technique, however, the other area cannot be monitored during magnification of the watch area. Even if a watch area is newly generated in the case such that a suspicious person appears in the monitoring area other than the watch area, a problem occurs such that the new watch area cannot be visually recognized. In order to magnify the watch area, panning, tilting and zooming are necessary in the surveillance camera. The operations are complicated.

As a monitoring technique capable of always monitoring a whole monitoring area and, simultaneously, visually recognizing a watch area in detail, a monitoring system of generating whole image data obtained by converting a whole captured image to an image of low resolution and trimmed image data obtained by trimming a watch area from the captured image, and recording/transferring the image data has been proposed (Japanese Patent Application Laid-Open No. 2004-120341).

In the monitoring technique of Japanese Patent Application Laid-Open No. 2004-120341, however, the resolution (image size) of a watch area is fixed, and an image of whole image data and an image of trimmed image data are recorded/transferred as independent images, so that the following problems occur.

Since the resolution of the watch area is constant irrespective of the size of a person to be watched, which varies between the case where the person is apart from the surveillance camera and the case where the person is near the surveillance camera, the size of the person in the watch area changes. It is therefore inconvenient to determine the person.

In addition, it is necessary to compress two kinds of image sequences of whole image data and trimmed image data in parallel. In the case of employing an image compressing method using information in the time axis direction, a restriction is imposed on mounting. Specifically, in an image compressing method realizing a high compression ratio by using information in the time axis direction such as the MPEG method using a P frame, image data has to be compared with image data in the past. Therefore, in the case of performing a compressing process while alternately switching between whole image data and trimmed image data, process of holding the whole image data in the past and the trimmed image data in the past and switching the image data in the past to be referred to in accordance with a switch in the compressing process between the whole image data and the trimmed image data is necessary. Since it is difficult to perform such a switching operation by an ASIC or the like as hardware for performing an image compressing process, mounting of an ASIC is limited, and it is inconvenient.

### SUMMARY OF THE INVENTION

The present invention is directed to an image capturing apparatus capable of transmitting image data to an image receiving apparatus.

The image capturing apparatus according to the present invention includes: (a) an image sensor for capturing an image of a subject; (b) a setter for setting a plurality of areas of different image sizes with respect to a captured image obtained by the image sensor; (c) an extractor for extracting a plurality of images corresponding to the plurality of areas set by the setter from the captured image; (d) a scaler for changing a size of each of the plurality of images extracted by the extractor, thereby generating a plurality of transmission images, each of which having a predetermined image size; and (e) a transmitter for transmitting transmission data obtained by compressing the plurality of transmission images to the image receiving apparatus. Consequently, convenience in distribution of a captured image can be improved.

In a preferred embodiment of the present invention, in the image capturing apparatus, the transmission data is data of a motion picture stream. Consequently, convenience in distribution of a motion picture stream improves.

The preset invention is also directed to an image distributing system having an image capturing apparatus capable of transmitting image data and an image receiving apparatus.

Therefore, an object of the present invention is to provide a technique of an image capturing apparatus realizing improved convenience in distribution of a captured image.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a functional configuration of a network camera according to a first preferred embodiment of the present invention;

FIG. 2 is a diagram illustrating an image distributing operation in the network camera of FIG. 1;

FIG. 3 is a block diagram showing a functional configuration of a network camera according to a second preferred embodiment of the present invention;

FIG. 4 is a diagram illustrating an image distributing operation in the network camera of FIG. 3;

FIG. 5 is a diagram illustrating an image distributing operation in a network camera according to a third preferred embodiment of the present invention;

FIG. 6 is a diagram showing a concrete example of the case where a human under tracking goes out of a monitoring area; and

FIG. 7 is a diagram illustrating display of a distributed image according to a modification of the present invention.

### DESCRIPTION OF THE PREFERRED EMBODIMENTS

### FIRST PREFERRED EMBODIMENT

Configuration of Network Camera

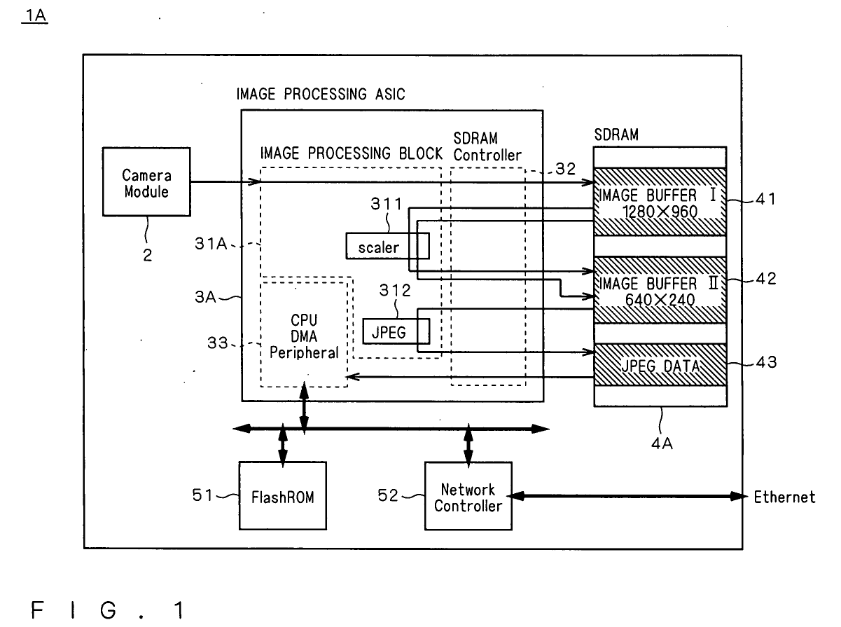

FIG. 1 is a block diagram showing a functional configuration of a network camera 1A according to a first preferred embodiment of the present invention.

The network camera 1A is constructed as an image capturing apparatus for distributing an image by using a network such as the Internet.

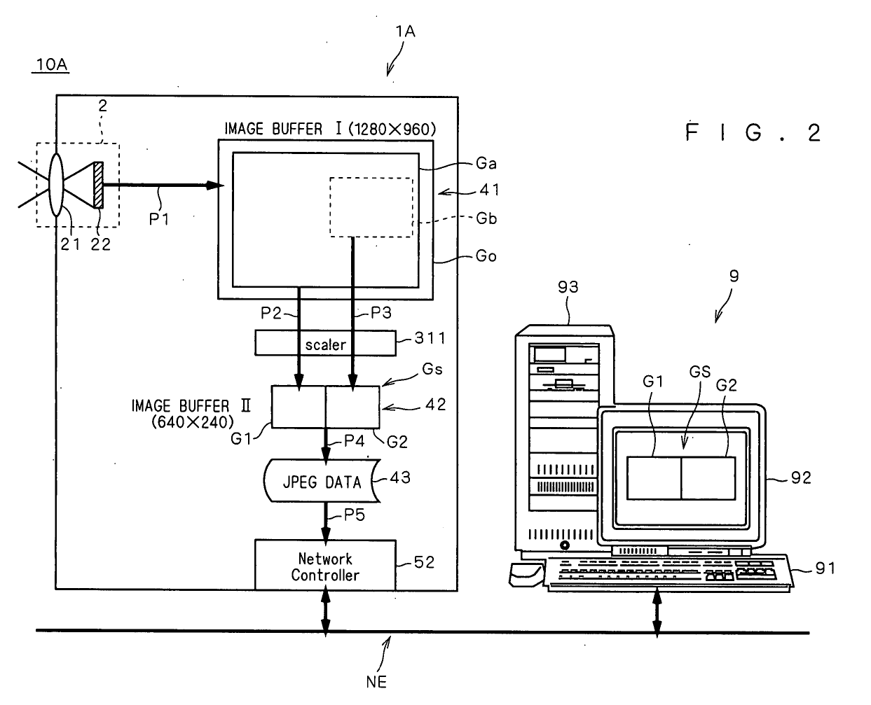

The network camera 1A includes an image capturing part 2, an image processing circuit 3A for performing imaging process on a captured image that is output from the image capturing part 2, and a storage 4A connected to the image capturing circuit 3A so as to be able to transmit data. The network camera 1A also includes a flash ROM 51 and a network controller 52 transmittably connected to the image processing circuit 3A. The network controller 52 transmits image data obtained by the image capturing part 2 to an external terminal 9 (see FIG. 2) via a network using, for example, the Ethernet.

The image capturing part 2 has a taking lens 21 (see FIG. 2) and an image capturing device 22 (see FIG. 2) for photoelectrically converting a subject light image formed by the taking lens 21 and outputting the resultant as an image signal. The image capturing device 22 is constructed as a CMOS sensor having, for example, 1280×960 pixels and performing YCC422 output.

The image processing circuit 3A is constructed as an image processing ASIC as a chip dedicated to image processing, and has an image processor 31, a memory controller 32 and an overall controller 33.

The image processor 31A has a scaler 311 for performing scaling by changing resolution of the image captured by the image capturing part 2 and a JPEG encoder 312 for compressing the image by the JPEG method.

The memory controller 32 is a part for controlling transmission/reception of image data or the like to/from the storage 4A.

The overall controller 33 functions as a CPU and a DMA controller. That is, the overall controller 33 performs control on the components of the network camera 1A and control on communications with the outside of the network 1A, and accesses the storage 4A to perform input/output control on data.

The storage 4A is constructed as an SDRAM. An image buffer I 41 for storing image data of 1280×960 pixels, an image buffer II 42 for storing image data of 640×240 pixels, and a buffer 43 for JPEG data for storing image data compressed by the JPEG encoder 312 are assigned.

Operation of Network Camera 1A

FIG. 2 is a diagram illustrating an image distributing operation in the network camera 1A.

The network camera 1A can distribute a captured image to the external terminal 9. The operation of an image distributing system 10A for distributing images will be described below. The terminal (image receiving apparatus) 9 is constructed as, for example, a personal computer (hereinafter, also referred to as “PC”) and has an operation part 91 constructed by a mouse and a keyboard, a display 92 taking the form of, for example, a liquid crystal display and capable of displaying an image, and a body 93 having a hard disk drive (HDD) and receiving transmission data from the network camera 1A.

In the network camera 1A, image data is sequentially transmitted/processed along paths (indicated by arrows) P1 to P5, thereby generating transmission data to be distributed to the terminal 9. The processes in the paths P1 to P5 will be sequentially described.

(1) Path P1

First, a light image of a subject incident via the taking lens 21 is photoelectrically converted by the image capturing device 22 having 1280×960 pixels, thereby generating an analog image signal. The image signal is input to the image processing circuit 3A where it is subjected to A/D conversion and image processes, and the resultant is written as a captured image Go into the image buffer I 41 for storing image data of 1280×960 pixels which is the same as the pixel number of the image capturing device 22.

(2) Path P2

An image capture range of the network camera 1A and a monitoring area desired to be monitored do not always coincide with each other due to limitations on mounting of the network camera 1A and the like. In this preferred embodiment, therefore, an image range of 1120×840 pixels corresponding to part of the captured image Go is regarded as a monitoring area Ga.

The monitoring area Ga is extracted from the captured image Go of 1280×960 pixels stored in the image buffer I 41 and input to the scaler 311 in the image processing circuit 3A. The scaler 311 reduces the size of an image of the input monitoring area Ga to 1/3.5 in length and breadth. The resultant is written as a whole image G1 having image size of 320×240 pixels into the left half of the image buffer II 42.

(3) Path P3

For example, a watch area Gb corresponding to the position and size designated by the user as a watch area with the operation part 91 of the terminal 9 is extracted from the captured image Go stored in the image buffer I 41, and the extracted watch area Gb is input to the scaler 311 in the image processing circuit 3A. In the scaler 311, scaling is performed on the image in the input watch area Gb, and the resultant is written as a watch image G2 having the image size of 320×240 pixels into the right half of the image buffer II 42. In the scaling, as data to be recorded in the JPEG encoder 312, information of the position and size of the monitoring area Gb is held as appendant information of the image buffer II 42.

By performing the processes in the paths P2 and P3, the whole image G1 of a wide angle obtained by reducing the monitoring area Ga is stored in the left half of the image buffer II 42, and the watch image G2 of a narrow angle obtained by reducing the watch area Gb corresponding to part of the monitoring area Ga is stored in the right half of the image buffer II 42. An integrated image Gs having 640×240 pixels obtained by combining the images G1 and G2 is generated.

That is, two image areas (the monitoring area Ga and the watch area Gb) of different image sizes are set with respect to the captured image Go, and two images corresponding to the image areas are extracted from the captured image Go. Each of the two extracted images is scaled by the scaler 311, and the resultant image is written in the image buffer II 42, thereby generating two transmission images (the whole image G1 and the watch image G2) and generating one integrated image Gs obtained by integrating the transmission images.

(4) Path P4

The integrated image Gs stored in the image buffer II 42 is read and input to the JPEG encoder 312. The integrated image Gs is compressed by the JPEG encoder 312, and the generated JPEG data is written into the buffer 43 for JPEG data in the storage 4A. In this case, the JPEG encoder 312 records the information of the position and size of the watch area Gb held in the image buffer II 42 into the JPEG header of the compressed image data.

(5) Path P5

The compressed image data of the integrated image Gs stored in the buffer 43 for JPEG data is read and transmitted to a network NE via the network controller 52. Consequently, transmission data obtained by performing the compressing process on the two transmission images (whole image G1 and watch image G2), that is, transmission data obtained by performing the compression process on the integrated image Gs is transmitted to the terminal 9.

By repeating the processes in the paths P1 to P5 at a frame rate designated in the network camera 1A, a motion picture stream of MJPEG is distributed from the network camera 1A to the terminal 9 via the network NE.

The terminal 9 which receives the motion picture stream decodes (performs decompressing process on) the JPEG data (transmission data) in the body 93, and displays the integrated image Gs of 640×240 pixels on the display 92. As a result, the user can visually recognize the whole image G1 corresponding to the whole monitoring area and the watch image G2 corresponding to part of the monitoring area at the same time.

When the terminal 9 which has received the motion picture stream sent from the network camera 1A stores the received stream data in the HDD in the body 93, the stream data can be retrieved and reproduced later.

Moreover, the part corresponding to the watch image G2 may be clearly shown as a frame in the whole picture G1 on the basis of the information of the position and size of the watch area Gb to be recorded in the JPEG header of distributed compressed image data, or a synthetic image obtained by fitting the watch image G2 into the enlarged whole image G1 may be generated and displayed.

Since the size of the image of the monitoring area and that of the image of the watch area in a captured image are changed and the resultant images are compressed and distributed as a single integrated image by the above-mentioned operations of the image distributing system 10A, the compressing process is facilitated and, on the reception side, the monitoring area and the watch area can be easily visually recognized. As a result, convenience in distribution of a captured image can be improved.

The network camera 1A combines the image of the monitoring area Ga and the image of the watch area Gb captured at the same time into a single integrated image Gs and distributes the integrated image Gs. Therefore, at the time of storing, retrieving and reproducing images in the terminal on the reception side, the whole image G1 and the watch image G2 which correspond to each other are always obtained without necessity of performing a special process. The apparatus configuration can be simplified.

### SECOND PREFERRED EMBODIMENT

Configuration of Network Camera

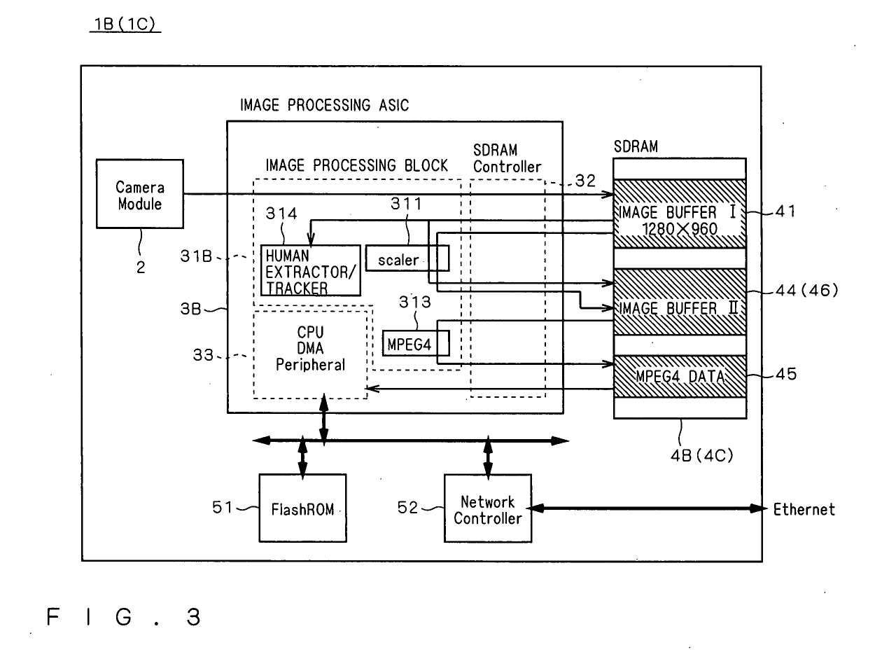

FIG. 3 is a block diagram showing a functional configuration of a network camera 1B according to a second preferred embodiment of the present invention.

The network camera 1B has a configuration similar to that of the network camera 1A of the first preferred embodiment except for the configurations of the image processor and the storage.

Specifically, an image processor 31B of the network camera 1B has the scaler 311 similar to that of the first preferred embodiment, a MPEG4 encoder 313 for performing an image compressing process by the MPEG4 method as a compression method using information in the time axis direction, and a human extractor/tracker 314.

The human extractor/tracker 314 can extract and track a human on the basis of an image captured and obtained by the image capturing part 2. A human can be extracted and tracked by, for example, detecting the eyes and legs as characteristic parts in determining a human from images sequentially captured. That is, by detecting both the eyes and legs specifying the size of a human, the position and size of a human (watch area) in a captured image can be obtained.

A storage 4B is constructed as an SDRAM. The image buffer I 41 of the same capacity as that in the first preferred embodiment, an image buffer II 44, and a buffer 45 for MPEG4 data for storing image data compressed by the MPEG4 encoder 313 are assigned to the storage 4B.

The image buffer II 44 has a storage capacity of storing image data of 480×240 pixels for the following reason. When the whole image of 320×240 pixels obtained by reducing the whole monitoring area and the watch image of 160×240 pixels obtained by reducing the portrait watch area assuming an upright image of a human are integrated to one image as described later, the image size of 480×240 pixels is achieved.

Operation of Network Camera 1B

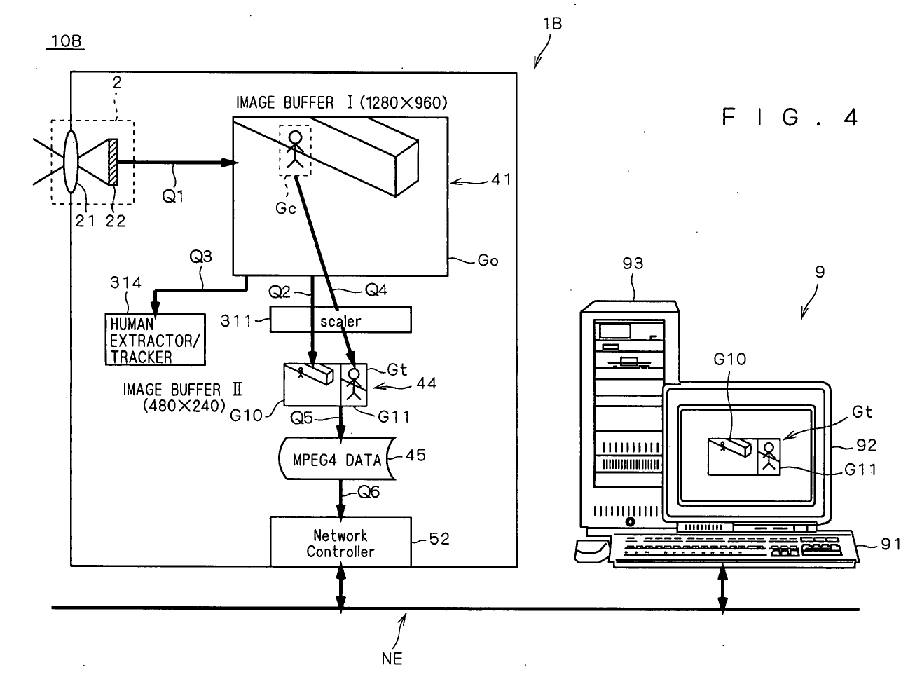

FIG. 4 is a diagram illustrating an image distributing operation in the network camera 1B.

The network camera 1B can distribute a captured image to the external terminal 9 in a manner similar to the first preferred embodiment. The operation of an image distributing system 10B for distributing images will be described below.

In the network camera 1B, image data is sequentially transmitted/processed along paths (indicated by arrows) Q1 to Q6, thereby generating transmission data to be distributed to the terminal 9. The processes in the paths Q1 to Q6 will be sequentially described.

(1) Path Q1

First, a light image of a subject incident via the taking lens 21 is photoelectrically converted by the image capturing device 22 having 1280×960 pixels, thereby generating an analog image signal. The image signal is input to the image processing circuit 3B where it is subjected to A/D conversion and image processes, and the resultant is written as a captured image Go into the image buffer I 41 for storing image data of 1280×960 pixels which is the same as the pixel number of the image capturing device 22.

(2) Path Q2

The captured image Go stored in the image buffer I 41 is read as an image indicative of the whole monitoring area, and input to the scaler 311 in the image processing circuit 3B. The scaler 311 reduces the size of the input capture image Go to ¼ in length and breadth. The resultant is written as a whole image G10 having image size of 320×240 pixels into the left part of the image buffer II 44.

(3) Path Q3

The captured image Go stored in the image buffer 141 is read and input to the human extractor/tracker 314 in the image processing circuit 3B. In the human extractor/tracker 314, a human is detected on the basis of the input captured image Go, and a watch area Gc according to the position and size of the human is set. In the case where a human is not detected from the captured image Go in the human extractor/tracker 314, a watch area according to the position and size which are predetermined in the captured image Go is set.

(4) Path Q4

The watch area Gc set in the human extractor/tracker 314 is extracted from the captured image Go stored in the image buffer I 41 and is input to the scaler 311 in the image processing circuit 3B. In the scaler 311, scaling is performed on the image in the input watch area Gc, and the resultant is written as a watch image G11 having the image size of 160×240 pixels into the right part of the image buffer II 44.

By performing the processes in the paths Q2 and Q4, the whole image G10 of a wide angle obtained by reducing the captured image Go is stored in the left part of the image buffer II 44, and the watch image G11 of a narrow angle obtained by reducing the watch area Gc extracted by the human extractor/tracker 314 is stored in the right part. An integrated image Gt having 480×240 pixels obtained by combining the images G10 and G11 is generated.

That is, two image areas (the whole area and the watch area Gc of the captured image Go) of different image sizes are set with respect to the captured image Go, and two images corresponding to the image areas are extracted from the captured image Go. Each of the two extracted images is scaled by the scaler 311, and the resultant image is written in the image buffer II 44, thereby generating two transmission images (the whole image G10 and the watch image G11) and generating one integrated image Gt obtained by integrating the transmission images.

(5) Path Q5

The integrated image Gt stored in the image buffer II 44 is read and input to the MPEG4 encoder 313. The integrated image Gt is compressed by the MPEG4 encoder 313, and the generated MPEG4 data is written into the buffer 45 for MPEG4 data in the storage 4B.

(6) Path Q6

The compressed image data of the integrated image Gt stored in the buffer 45 for MPEG4 data is read and transmitted to the network NE via the network controller 52. Consequently, transmission data obtained by performing the compressing process on the two transmission images (whole image G10 and watch image G11), that is, transmission data obtained by performing the compression process on the integrated image Gt is transmitted to the terminal 9.

By repeating the processes in the paths Q1 to Q6 at a frame rate designated in the network camera 1B, a motion picture stream of MPEG4 is distributed from the network camera 1A to the terminal 9 via the network NE.

The terminal 9 which receives the motion picture stream decodes (performs decompressing process on) the MPEG4 data (transmission data) in the body 93, and displays the integrated image Gt of 480×240 pixels on the display 92. As a result, the user can simultaneously visually recognize the whole image G10 corresponding to the whole monitoring area and the watch image G11 corresponding to part of the monitoring area.

When the terminal 9 which has received the motion picture stream sent from the network camera 1B stores the received stream data in the HDD in the body 93, the stream data can be retrieved and reproduced later.

By the operation of the image distributing system 10B, the size of a captured image and that of the image of the watch area of a size according to a human are changed and the resultant images are compressed and distributed as a single integrated image. Thus, the compressing process is facilitated and, on the reception side, the monitoring area and the watch area can be easily visually recognized. As a result, convenience in distribution of a captured image can be improved.

The network camera 1B combines the captured image (the whole image of the monitoring area) Go and the image (detailed image) of the watch area Gc captured at the same time into a single integrated image Gt and distributes the integrated image Gt. Therefore, at the time of storing, retrieving and reproducing images in the terminal on the reception side, it is not necessary to perform a special process but by decoding one MPEG4 stream, the whole image G10 and the watch image G11 which always correspond to each other are obtained. Thus, the apparatus configuration can be simplified.

### THIRD PREFERRED EMBODIMENT

A network camera 1C according to a third preferred embodiment of the present invention has a configuration similar to that of the network camera 1B of the second preferred embodiment shown in FIG. 3 except for the configuration of the image buffer II.

Specifically, an image buffer II 46 of the network camera 1C has a capacity of storing image data of 800×240 pixels. In the network camera 1C of this preferred embodiment, different from the network camera 1B of the second preferred embodiment limited to extract one human, three humans can be extracted at the maximum. The storage capacity of the image buffer II 46 is set to the image size of 800×240 pixels so that three images of 160×240 pixels, each obtained by reducing the extracted watch area, and an image of 320×240 pixels obtained by reducing the whole monitoring area can be stored.

Operation of Network Camera 1C

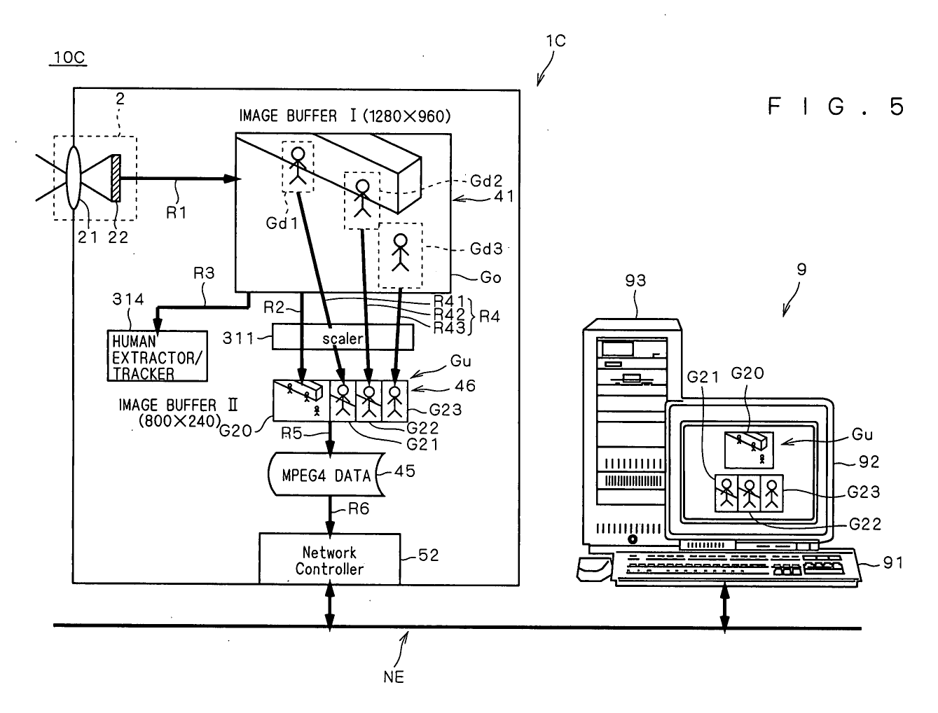

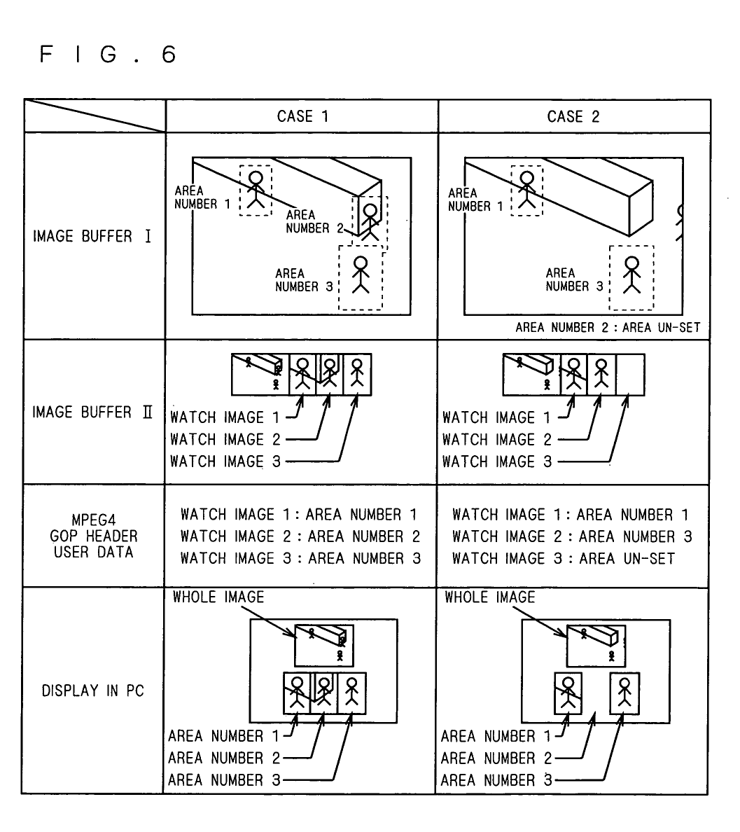

FIG. 5 is a diagram illustrating an image distributing operation in the network camera 1C. FIG. 6 is a diagram showing a concrete example of the case where a human tracked goes out from a monitoring area. In FIG. 6, Case 1 shows the case where three humans are detected in the monitoring area, and Case 2 shows the case where one human moves out of the monitoring area.

The network camera 1C can distribute a captured image to the external terminal 9 in a manner similar to the second preferred embodiment. The operation of an image distributing system 10C for distributing images will be described below.

In the network camera 1C, image data is sequentially transmitted/processed along paths R1 to R6 shown in FIG. 5, thereby generating transmission data to be distributed to the terminal 9. The processes in the paths R1 to R6 will be sequentially described with reference o FIG. 6.

(1) Path R1

In a manner similar to the second preferred embodiment, an image signal output from the image capturing device 22 is input to the image processing circuit 3B where it is subjected to A/D conversion and image processes, and the resultant is written as a captured image Go into the image buffer I 41 for storing image data of 1280×960 pixels which is the same as the number of pixels of the image capturing device 22.

(2) Path R2

The captured image Go stored in the image buffer I 41 is read as an image indicative of the whole monitoring area, and input to the scaler 311 in the image processing circuit 3B. The scaler 311 reduces the size of the input capture image Go to ¼ in length and breadth. The resultant is written as the whole image G10 having 320×240 pixels into the left part of the image buffer II 46.

(3) Path R3

The captured image Go stored in the image buffer I 41 is read and input to the human extractor/tracker 314 in the image processing circuit 3B. The human extractor/tracker 314 detects three humans at the maximum on the basis of the input captured image Go, sets watch areas Gd1 to Gd3 according to the positions and sizes of the humans, gives area numbers 1 to 3 to the watch areas Gd1 to Gd3, respectively, and stores them into the human extractor/tracker 314.

In the numbering, past extraction results stored in the human extractor/tracker 314 are referred to and, on the basis of information such as the preset positions, sizes, and movement vectors of the watch areas Gd1 to Gd3, numbers are designated so as to coincide with area numbers of the extraction results of last time of the watch areas Gd1 to Gd3.

In the case where the human to be tracked goes out of the monitoring area (image capturing range) during tracking of the humans in the watch areas Gd1 to Gd3 as shown in FIG. 6 or the number of humans to be detected becomes less than three, a flag indicating that a watch area is not set (hereinafter, referred to as “area un-set flag”) is set in an area number.

(4) Path R4

The watch areas Gd1 to Gd3 set in the human extractor/tracker 314 are extracted from the captured image Go stored in the image buffer I 41 and are input to the scaler 311 in the image processing circuit 3B. In the scaler 311, scaling is performed on the images in the watch areas in which the area un-set flag is not set out of the watch areas Gd1 to Gd3 in order of the area numbers, and the resultant is written as watch images G21 to G23 each having the image size of 160×240 pixels into the right part of the image buffer II 46 (see paths R41 to R43). When the number of humans to be extracted is less than three, a specific value (for example, black) is input in a watch image including no human in the image buffer II 46, and the watch image is cleared.

By performing the processes in the paths R2 and R4, the whole image G20 of a wide angle obtained by reducing the captured image Go is stored in the left part of the image buffer II 46, and the watch images G21 to G23 of a narrow angle obtained by reducing the watch areas Gd1 to Gd3 extracted by the human extractor/tracker 314 are stored in the right part of the image buffer II 46. An integrated image Gu having 800×240 pixels obtained by combining the images is generated.

(5) Path R5

The integrated image Gu stored in the image buffer II 46 is read and input to the MPEG4 encoder 313. The integrated image Gu is compressed by the MPEG4 encoder 313, and the generated MPEG4 data is written into the buffer 45 for MPEG4 data in the storage 4C.

For example, in the case where the human designated with the area number 2 goes out from the monitor area and a change occurs in a result of extraction of the watch area by the human extractor/tracker 314 like the case where a transition occurs from the case 1 to the case 2 shown in FIG. 6, the MPEG4 encoder 313 changes the data in the user data part of the GOP header of MPEG4. Concretely, although the area numbers 1 to 3 are given to the watch images 1 to 3, respectively, in the case 1, in the case 2, the area number 3 is given to the watch image 2 by using the numbering in the case 1, and the area un-set flag is given to the watch image 3.

The MPEG4 encoder 313 encodes the whole integrated image Gu of 800×240 pixels irrespective of whether the area un-set flag is given to the watch image or not, that is, whether each of the watch images is valid or not.

(6) Path R6

The compressed image data of the integrated image Gu stored in the buffer 45 for MPEG4 data is read and transmitted to the network NE via the network controller 52.

By repeating the processes in the paths R1 to R6 at a frame rate designated in the network camera 1C, a motion picture stream of MPEG4 is distributed from the network camera 1A to the terminal 9 via the network NE.

The terminal 9 which receives the motion picture stream decodes the MPEG4 data in the body 93, and displays the integrated image Gu on the display 92. At this time, by referring to the user data part in the GOP header of the MPEG4 data, the area number corresponding to each watch image is obtained. At the time of displaying watch images, since the area number of the watch image corresponds to the human tracked, each watch image is displayed in the same screen corresponding to the area number as shown in FIG. 6.

When the terminal 9 which has received the motion picture stream sent from the network camera 1C stores the received stream data in the HDD in the body 93, the stream data can be retrieved and reproduced later.

By the operation of the image distributing system 10C, effects similar to those of the image distributing system 10B are exhibited. Since a plurality of watch areas can be set in a monitoring area, convenience in monitoring further improves.

In the image distributing system 10C, when the number of valid watch images changes according to the presence/absence of an area un-set flag, it is possible to change the VOL of MPEG4 data, switch the image size from, for example, 800×240 pixels to 640×240 pixels, and encode an integrated image obtained by integrating only a valid watch image and a whole image by the MPEG4 encoder 314.

### MODIFICATIONS

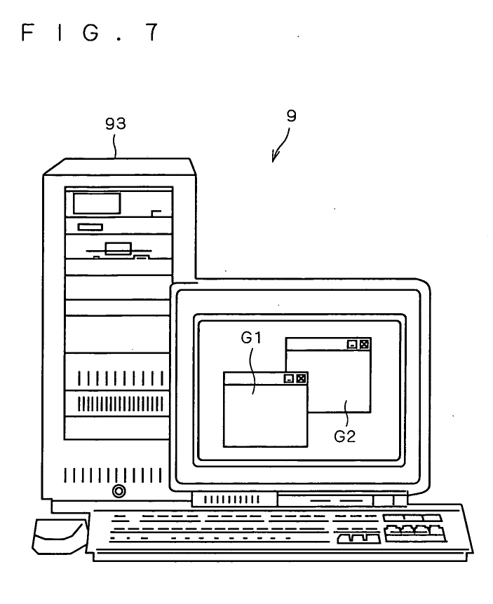

In the first preferred embodiment, it is not indispensable to display the whole image G1 and the watch image G2 in parallel on the display 92 of the terminal 9 as shown in FIG. 2. The whole image G1 and the watch image G2 may be displayed in separate windows as shown in FIG. 7.

Similarly, also in the second preferred embodiment, the whole image G10 of 320×240 pixels and the watch image G11 of 160×240 pixels may be displayed in separate windows.

It is not always necessary to employ a CMOS sensor as the image capturing device in each of the foregoing preferred embodiments but a CCD in which each of RGB pixels is subjected to Bayer arrangement may be also employed.

In each of the foregoing preferred embodiments, it is not always necessary to read a captured image stored in the image buffer I and perform the scaling process. Alternatively, the scaling process may be performed in parallel with the process of storing a captured image into the image buffer I, and the resultant may be stored in the image buffer II.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus capable of transmitting image data to an image receiving apparatus, comprising:
(a) an image sensor for capturing an image of a subject;
(b) a setter for setting a plurality of areas of different image sizes with respect to a captured image obtained by said image sensor;
(c) an extractor for extracting a plurality of images corresponding to said plurality of areas set by said setter from said captured image;
(d) a scaler for changing a size of each of said plurality of images extracted by said extractor, thereby generating a plurality of transmission images, each of which having a predetermined image size; and
(e) a transmitter for transmitting transmission data obtained by compressing said plurality of transmission images to said image receiving apparatus.

2. The image capturing apparatus according to claim 1, wherein
said transmission data is data of a motion picture stream.

3. The image capturing apparatus according to claim 2, wherein said transmitter includes:
(e-1) a compressor for performing a compressing process in a time axis direction, thereby generating said transmission data.

4. An image capturing apparatus capable of transmitting image data to an image receiving apparatus, comprising:
(a) an image sensor for capturing an image of a subject;
(b) a setter for setting a plurality of areas of different image sizes with respect to a captured image obtained by said image sensor;
(c) an extractor for extracting a plurality of images corresponding to said plurality of areas set by said setter from said captured image;
(d) an image integrator for performing a predetermined integrating process on a plurality of images extracted by said extractor, thereby generating a single integrated image, said predetermined integrating process being a process of integrating a plurality of transmission images generated by changing a size of one or more images in said plurality of images; and
(e) a transmitter for transmitting transmission data obtained by compressing said single integrated image to said image receiving apparatus.

5. The image capturing apparatus according to claim 4, wherein
said transmission data is data of a motion picture stream.

6. The image capturing apparatus according to claim 5, wherein said transmitter includes:
(e-1) a compressor for performing a compressing process in a time axis direction, thereby generating said transmission data.

7. An image distributing system comprising:
(a) an image capturing apparatus capable of transmitting image data, said image capturing apparatus including:
(a-1) an image sensor for capturing an image of a subject;
(a-2) a setter for setting a plurality of areas of different image sizes with respect to a captured image obtained by said image sensor;
(a-3) an extractor for extracting a plurality of images corresponding to said plurality of areas set by said setter from said captured image;
(a-4) a scaler for changing a size of each of said plurality images extracted by said extractor, thereby generating a plurality of transmission images, each of which having a predetermined image size; and
(a-5) a transmitter for transmitting transmission data obtained by compressing said plurality of transmission images to said image receiving apparatus; and
(b) an image receiving apparatus including:
(b-1) a display capable of displaying an image;
(b-2) a receiver for receiving said transmission data; and
(b-3) a display controller for decompressing said transmission data received by said receiver and making said plurality of transmission images displayed on said display.

8. The image distributing system according to claim 7, wherein
said transmission data is data of a motion picture stream.

9. The image distributing system according to claim 8, wherein said transmitter includes:
a compressor for performing a compressing process in a time axis direction, thereby generating said transmission data.

10. The image distributing system according to claim 7, wherein
said display controller makes said plurality of transmission images displayed in parallel.

11. The image distributing system according to claim 7, wherein
said display controller makes said plurality of transmission images displayed on different windows.

12. The image distributing system according to claim 7, wherein
at the time of displaying said plurality of transmission images on said display, said display controller makes a frame indicative of an inclusion relation of said plurality of transmission images superimposed on a transmission image.

13. The image distributing system according to claim 7, wherein the image capturing apparatus further includes:
(a-6) a detector for detecting a human, and
said plurality of images have a human image in which said human detected by said detector appears.

14. The image distributing system according to claim 13, wherein said detector includes:
a determinator for determining a size of said human, and
said human is shown in a predetermined size based on said size of said human determined by said determinator part in said human image.

15. The image distributing system according to claim 13, wherein
said transmission data is data of a motion picture stream, and
said human image is an image obtained by tracking said human detected by said detector.

16. An image distributing system comprising:
(a) an image capturing apparatus capable of transmitting image data, said image capturing apparatus including:
(a-1) an image sensor for capturing an image of a subject;
(a-2) a setter for setting a plurality of areas of different image sizes with respect to a captured image obtained by said image sensor;
(a-3) an extractor for extracting a plurality of images corresponding to said plurality of areas set by said setter from said captured image;
(a-4) an image integrator for performing a predetermined integrating process on a plurality of images extracted by said extractor, thereby generating a single integrated image, said predetermined integrating process being a process of integrating a plurality of transmission images generated by changing a size of one or more images in said plurality of images; and
(a-5) a transmitter for transmitting transmission data obtained by compressing said single integrated image to said image receiving apparatus; and
(b) an image receiving apparatus including:
(b-1) a display capable of displaying an image;
(b-2) a receiver for receiving said transmission data; and
(b-3) a display controller for decompressing said transmission data received by said receiver and making said plurality of images displayed on the display.

17. The image distributing system according to claim 16, wherein
said transmission data is data of a motion picture stream.

18. The image distributing system according to claim 17, wherein said transmitter includes:
a compressor for performing a compressing process in a time axis direction, thereby generating said transmission data.

19. The image distributing system according to claim 16, wherein
said display controller makes said plurality of images displayed in parallel.

20. The image distributing system according to claim 16, wherein
said display controller makes said plurality of images displayed in parallel.
